(19) United States
(12) Patent Application Publication
(10) Pub. No.: US 2024/0083030 A1
(43) Pub. Date: Mar. 14, 2024

(54) METHOD AND APPARATUS FOR PATH OPTIMIZATION, ROBOT AND STORAGE MEDIUM

(71) Applicant: JINGDONG TECHNOLOGY INFORMATION TECHNOLOGY CO., LTD., Beijing (CN)

(72) Inventors: Yongyu CHEN, Beijing (CN); Chao WANG, Beijing (CN); Xiujun YAO, Beijing (CN); Chenguang GUI, Beijing (CN); Lihua CUI, Beijing (CN)

(73) Assignee: JINGDONG TECHNOLOGY INFORMATION TECHNOLOGY CO., LTD., Beijing (CN)

(21) Appl. No.: 18/264,236

(22) PCT Filed: Dec. 14, 2021
(86) PCT No.: PCT/CN2021/137669

§ 371 Date: Aug. 3, 2023

(30) Foreign Application Priority Data
Feb. 4, 2021 (CN) 202110158712.6

(51) Int. Cl. B25J 9/16; G05D 1/02

(52) U.S. Cl. CPC B25J 9/1666; G05D 1/0221; G05D 2201/0217

(57) ABSTRACT

Disclosed are a method and an apparatus for path optimization, a robot and a storage medium. The method includes: acquiring an initial path of a robot, and iteratively optimizing the initial path until a preset iteration termination condition is met to obtain obstacle avoidance path of the robot: acquiring an iteration path corresponding to a current iteration process, determining a smoothness cost and a smoothness optimal gradient; determining a robot's footprint contour corresponding to the iteration path point, and searching for a first nearest obstacle distance; determining an obstacle cost corresponding to the iteration path and an obstacle optimal gradient corresponding to the iteration path point based on the first nearest obstacle distance; adjusting the iteration path point to acquire an iteration path corresponding to a next iteration process; inputting the smoothness cost and the obstacle cost to a preset objective function.

### CROSS-REFERENCE TO RELATED APPLICATIONS

This application is the National Stage of International Application PCT/CN2021/137669, filed on Dec. 14, 2021, which claims priority to Chinese Patent Application No. 202110158712.6, entitled “method and apparatus for Path Optimization, robot and storage medium” and filed with China National Intellectual Property Administration on Feb. 4, 2021. All of the aforementioned applications are incorporated herein by reference in their entireties.

### TECHNICAL FIELD

This application generally relates to the technical field of robotics, and more particularly to a method and an apparatus for path optimization, a robot and a storage medium.

### BACKGROUND

At present, the local path planning of robot can be roughly divided into: constructing an initial path by a sampling-based path planning method, where the initial path can meet the requirements of passing through and obstacle avoidance, but the smoothness generally does not meet the requirements; therefore, a method based on numerical optimization is adopted to optimize the initial path, where in the process of initial path optimization, smoothness optimization should be considered, at the same time, it is necessary to optimize the distance from obstacles so as to ensure a moderate distance between the robot and obstacles.

In related technologies, for some small and symmetrical robots, in the process of initial path optimization of the robot, it is usually necessary to use the nearest obstacle distance corresponding to the centroid coordinates of the robot to participate in obstacle distance optimization.

### SUMMARY

In a first aspect, this application relates to a method for path optimization, the method includes:
acquiring an initial path of a robot, and iteratively optimizing the initial path based on the following steps until a preset iteration termination condition is met to obtain obstacle avoidance path of the robot:
acquiring an iteration path corresponding to a current iteration process, determining a smoothness cost corresponding to the iteration path and a smoothness optimal gradient corresponding to an iteration path point in the iteration path;
determining a robot's footprint contour corresponding to the iteration path point, and searching for a first nearest obstacle distance corresponding to the footprint contour;
determining an obstacle cost corresponding to the iteration path and an obstacle optimal gradient corresponding to the iteration path point based on the first nearest obstacle distance;
adjusting the iteration path point based on the smoothness optimal gradient and the obstacle optimal gradient to acquire an iteration path corresponding to a next iteration process; and
inputting the smoothness cost and the obstacle cost to a preset objective function.

In some embodiments, determining the robot's footprint contour corresponding to the iteration path point includes:
acquiring a heading angle corresponding to the iteration path point and determining a footprint contour of the robot corresponding to the heading angle;
selecting footprint contour points of the robot corresponding to the iteration path point from the footprint contour based on a preset rule for selecting contour points.

In some embodiments, searching for the first nearest obstacle distance corresponding to the footprint contour includes:
searching for first nearest obstacle distances corresponding to the footprint contour points in a preset distance map.

In some embodiments, determining the obstacle cost corresponding to the iteration path and the obstacle optimal gradient corresponding to the iteration path point based on the first nearest obstacle distance includes:
selecting, from the footprint contour points, a footprint contour point with a smallest first nearest obstacle as a target footprint contour point corresponding to the iteration path point;
determining an obstacle cost corresponding to the iteration path by using the first nearest obstacle distance corresponding to the target contour point;
determining an away-from-obstacle gradient corresponding to the target footprint contour point; and
determining an obstacle optimal gradient corresponding to the iteration path point by using the first nearest obstacle distance and the away-from-obstacle gradient corresponding to the target contour point.

In some embodiments, determining the obstacle cost corresponding to the iteration path by using the first nearest obstacle distance corresponding to the target contour point includes:
inputting the first nearest obstacle distance corresponding to the target contour point to a preset obstacle cost algorithm; and
acquiring an obstacle cost corresponding to the iteration path point output by the obstacle cost algorithm, and summarizing the obstacle cost corresponding to the iteration path point to obtain the obstacle cost corresponding to the iteration path.

In some embodiments, the obstacle cost algorithm includes:

$${f}_{o} = \{ \begin{matrix}{( {d}_{min} - {d}_{δ} )}^{2} , & {d}_{min} < {d}_{δ} \\ 0 , & {d}_{min} \geq {d}_{δ}\end{matrix} ;$$

where, the fₒ is an obstacle cost corresponding to the iteration path point, the dₘᵢₙ is the first nearest obstacle distance corresponding to the target contour point, the d_{δ} is a preset distance.

In some embodiments, determining the away-from-obstacle gradient corresponding to the target footprint contour point includes:
determining a neighbor point corresponding to the target footprint contour point, and searching for a second nearest obstacle distance corresponding to the neighbor point;
selecting, from the neighbor points, a first neighbor point with a largest second nearest obstacle distance and a second neighbor point with a smallest second nearest obstacle distance;
determining a distance between the first neighbor point and the second neighbor point, and determining the distance as the away-from-obstacle gradient corresponding to the target footprint contour point.

In some embodiments, determining the obstacle optimal gradient corresponding to the iteration path point by using the first nearest obstacle distance and the away-from-obstacle gradient corresponding to the target contour point includes:
inputting the away-from-obstacle gradient and the first nearest obstacle distance corresponding to the target contour point to a preset obstacle optimal gradient algorithm; and
acquiring an obstacle optimal gradient corresponding to the iteration path point output by the obstacle optimal gradient algorithm.

In some embodiments, the obstacle cost algorithm includes:

$$\frac{\partial {f}_{o}}{\partial x} = \{ \begin{matrix}2 * ( {d}_{min} - {d}_{δ} ) * {grad}_{min} , & {d}_{min} < {d}_{δ} \\ 0 , & {d}_{min} \geq {d}_{δ}\end{matrix} ;$$

where, the ∂fₒ/∂ₓ the obstacle optimal gradient, the dₘᵢₙ is the first nearest obstacle distance corresponding to the target contour point, the d_{δ} is a preset distance, the gradₘᵢₙ is the away-from-obstacle gradient.

In some embodiments, adjusting the iteration path points based on the smoothness optimal gradient and the obstacle optimal gradient to acquire the iteration path corresponding to the next iteration process includes:
summarizing the smoothness optimal gradient and the obstacle optimal gradient to obtain an integrated gradient; and
adjusting the iteration path point by using the integrated gradient to obtain an iteration path corresponding to a next iteration process.

In some embodiments, iteratively optimizing the initial path until the preset iteration termination condition is met includes:
iteratively optimizing the initial path until an objective function satisfies a convergence condition, until the number of iterations reaches a preset number of iterations or until the iteration duration reaches a preset duration.

In some embodiments, where the objective function includes:

$${min}_{x} {λ}_{1} {f}_{ns} + {λ}_{2} {f}_{no} ;$$

where, the fₙₛ is the smoothness cost, the fₙₒ is the obstacle cost, the x is coordinates of the iteration path point.

In a second aspect, this application also relates to an apparatus for path optimization, the apparatus including:
a path acquisition module, configured for acquiring an initial path of a robot;
a path optimization module, configured for iteratively optimizing the initial path based on the following steps until a preset iteration termination condition is met to obtain obstacle avoidance path of the robot:
acquiring an iteration path corresponding to a current iteration process, determining a smoothness cost corresponding to the iteration path and a smoothness optimal gradient corresponding to an iteration path point in the iteration path;
determining a robot's footprint contour corresponding to the iteration path point, and searching for a first nearest obstacle distance corresponding to the footprint contour;
determining an obstacle cost corresponding to the iteration path and an obstacle optimal gradient corresponding to the iteration path point based on the first nearest obstacle distance;
adjusting the iteration path point based on the smoothness optimal gradient and the obstacle optimal gradient to acquire an iteration path corresponding to a next iteration process; and
inputting the smoothness cost and the obstacle cost to a preset objective function.

In a third aspect, this application also relates to a robot, including a processor, a communication interface, a memory and a communication bus, where the processor, the communication interface and the memory communicate with each other through the communication bus;

the memory is configured for storing computer programs; and

the processor is configured to implement the method for path optimization according to the present application.

In a fourth aspect, this application also relates to a storage medium, where instructions are stored on the storage medium, the program, when executed by a processor, implements the method for path optimization according to the present application.

In a fifth aspect, this application relates to a computer program product including instructions that, when run on a computer, cause the computer to perform method for path optimization according to the present application above.

In some embodiments, in the present application, by acquiring an initial path of a robot, and iteratively optimizing the initial path based on the following steps until a preset iteration termination condition is met to obtain obstacle avoidance path of the robot: acquiring an iteration path corresponding to a current iteration process, determining a smoothness cost corresponding to the iteration path and a smoothness optimal gradient corresponding to an iteration path point in the iteration path; determining a robot's footprint contour corresponding to the iteration path point, and searching for a first nearest obstacle distance corresponding to the footprint contour; determining an obstacle cost corresponding to the iteration path and an obstacle optimal gradient corresponding to the iteration path point based on the first nearest obstacle distance; adjusting the iteration path point based on the smoothness optimal gradient and the obstacle optimal gradient to acquire an iteration path corresponding to a next iteration process; and inputting the smoothness cost and the obstacle cost to a preset objective function. Thus, in a process of the initial path optimization of a robot, the nearest obstacle distance corresponding to the robot's footprint contour is used to participate in the obstacle distance optimization, which can get a more reasonable and smooth obstacle avoidance path of the robot.

### BRIEF DESCRIPTION OF THE DRAWINGS

The accompanying drawings which are incorporated in and constitute a part of the specification illustrate embodiments consistent with the application and together with the description serve to explain the principles of the application.

In order to more clearly explain the technical solution of this application, the drawings of this application will be briefly introduced below, and it will be obvious that other drawings can be acquired from these drawings without creative labor for those of ordinary skill in the art.

FIG. 1 is a schematic diagram of the implementation flow of a method for path optimization shown in an embodiment of the present application.

FIG. 2 is a schematic diagram of the implementation flow of another method for path optimization shown in an embodiment of the present application.

FIG. 3 is a schematic diagram of the effect of selecting footprint contour of the robot shown in an embodiment of the present application.

FIG. 4 is an effect schematic diagram of a first nearest obstacle distance corresponding to the footprint contour of the robot shown in an embodiment of the present application.

FIG. 5 is an effect schematic diagram of target footprint contour points corresponding to iteration path points shown in an embodiment of the present application.

FIG. 6 is an effect schematic diagram of 8 neighbor points corresponding to a target footprint contour point shown in an embodiment of the present application.

FIG. 7 is a schematic diagram of the effect of selecting a first neighbor point and a second neighbor point shown in an embodiment of the present application.

FIG. 8 is a schematic structural diagram of an apparatus for path optimization shown in an embodiment of the present application.

FIG. 9 is a structural schematic diagram of a robot shown in an embodiment of the present application.

### DETAILED DESCRIPTION OF THE EMBODIMENTS

In order to make the purposes, technical aspects and advantages of the disclosed embodiments clearer, the technical aspects of the disclosed embodiments will be clearly and completely described below in conjunction with the accompanying drawings in the disclosed embodiments, and it will be apparent that the described embodiments are part of, but not all of, the embodiments of the disclosed embodiments. Based on the embodiments in the present application all other embodiments acquired without creative effort by those of ordinary skill in the art fall within the scope of protection of the present application.

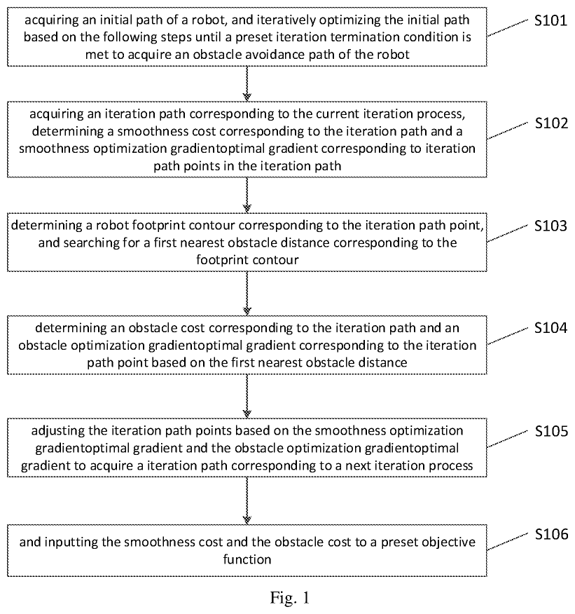

FIG. 1 is a schematic diagram of the implementation flow of a method for path optimization provided by the present application. The method can be applied to a robot, which may include the following steps:
S101, acquiring an initial path of a robot, and iteratively optimizing the initial path based on the following steps until a preset iteration termination condition is met to acquire an obstacle avoidance path of the robot;
S102, acquiring an iteration path corresponding to the current iteration process, determining a smoothness cost corresponding to the iteration path and a smoothness optimal gradient corresponding to iteration path points in the iteration path;
S103, determining a robot footprint contour corresponding to the iteration path point, and searching for a first nearest obstacle distance corresponding to the footprint contour;
S104, determining an obstacle cost corresponding to the iteration path and an obstacle optimal gradient corresponding to the iteration path point based on the first nearest obstacle distance;
S105, adjusting the iteration path points based on the smoothness optimal gradient and the obstacle optimal gradient to acquire an iteration path corresponding to a next iteration process; and
S106, and inputting the smoothness cost and the obstacle cost to a preset objective function.

In some embodiments, an initial path of a robot may be constructed by a sampling-based path planning method, for an initial path of a robot, it typically includes n path points ({x₁, y₁}, . . . , {xₙ, yₙ}).

In some embodiments, for an initial path of a robot, the initial path may be iteratively optimized based on steps S102 to S106 until a preset iteration termination condition is satisfied to acquire an obstacle avoidance path of the robot.

In some embodiments, the initial path may be iteratively optimized based on steps S102 to S106 until the objective function satisfies a convergence condition.

In some embodiments, the initial path may be iteratively optimized based on the following steps S102 to S106 until the number of iterations reaches a preset number of iterations.

In some embodiments, the initial path may be iteratively optimized based on steps S102 to S106 until the iteration duration reaches a preset duration.

In some embodiments, an iteration path corresponding to the current iteration process is acquired, and a smoothness cost corresponding to the iteration path and a smoothness optimization, where methods for determination the smoothness cost, the smoothness optimal gradient and the like can be inquired in related literature, and will not be described in the embodiments of the present application.

It should be noted that for an iteration path corresponding to the current iterative process, if the current iterative process is a first iterative process, the iteration path is an initial path; if the current iterative process is not the first iterative process, in the last iterative process, an iteration path corresponding to the last iterative process is adjusted to acquire the iteration path corresponding to the current iterative process.

In some embodiments, for an acquired iteration path corresponding to a current iterative process, determine a robot footprint contour corresponding to an iteration path point in the iteration path is determined, and search for a first nearest obstacle distance (i.e., a distance from the nearest obstacle) corresponding to the footprint contour, so that an obstacle cost corresponding to the iteration path and an obstacle optimal gradient corresponding to the iteration path point in the iteration path can be determined based on the first nearest obstacle distance.

In some embodiments, for an iteration path corresponding to the current iteration process, determining the robot's footprint contours respectively corresponding to iteration path points (xᵢ,yᵢ) in the iteration path, as shown in Table 1 below, and searching for first nearest obstacle distances corresponding to the footprint contours, so that based on these first nearest obstacle distances, the obstacle cost corresponding to the iteration path and the obstacle optimal gradient corresponding to the iteration path points in the iteration path can be determined.

TABLE 1

| iteration path point | robot footprint contour |
|---|---|
| (x₁, y₁) | robot footprint contour 1 |
| . . . | . . . |
| (xₙ, yₙ) | robot footprint contour n |

In some embodiments, for the smoothness optimal gradient corresponding to the iteration path points in the iteration path and the obstacle optimal gradient corresponding to the iteration path points in the iteration path, the iteration path points in the iteration path are adjusted based on the smoothness optimal gradient and the obstacle optimal gradient (in some embodiments, the coordinates of the iteration path points are adjusted) to acquire the corresponding iteration path in the next iteration process.

In some embodiments, for an iteration path point in an iteration path (xᵢ,yᵢ) the corresponding smoothness optimal gradient, and the iteration path points in the iteration path (xᵢ,yᵢ) the corresponding obstacle optimal gradient, and based on the smoothness optimal gradient and the obstacle optimal gradient, the iteration path points in the iteration path (xᵢ,yᵢ), so as to acquire the corresponding iteration path in the next iteration process.

In some embodiments, for the smoothness cost corresponding to the iteration path and the obstacle cost corresponding to the iteration path, the smoothness cost and the obstacle cost may be output into a preset objective function, which is shown below.

$${min}_{x} {λ}_{1} {f}_{ns} + {λ}_{2} {f}_{no} ;$$

Where the fₙₛ is a smoothness cost, the fₙₒ is an obstacle cost, the x is coordinates of the iteration path points, λ₁ is a weight of smoothness cost, λ₂ is a weight of the obstacle cost.

Through the description of the technical solution provided by an embodiment of the present application, acquiring an initial path of a robot, and iteratively optimizing the initial path based on the following steps until a preset iteration termination condition is met to obtain obstacle avoidance path of the robot: acquiring an iteration path corresponding to a current iteration process, determining a smoothness cost corresponding to the iteration path and a smoothness optimal gradient corresponding to an iteration path point in the iteration path; determining a robot's footprint contour corresponding to the iteration path point, and searching for a first nearest obstacle distance corresponding to the footprint contour; determining an obstacle cost corresponding to the iteration path and an obstacle optimal gradient corresponding to the iteration path point based on the first nearest obstacle distance; adjusting the iteration path point based on the smoothness optimal gradient and the obstacle optimal gradient to acquire an iteration path corresponding to a next iteration process; and inputting the smoothness cost and the obstacle cost to a preset objective function. Thus, in a process of the initial path optimization of a robot, the nearest obstacle distance corresponding to the robot's footprint contour is used to participate in the obstacle distance optimization, which can get a more reasonable and smooth obstacle avoidance path of the robot.

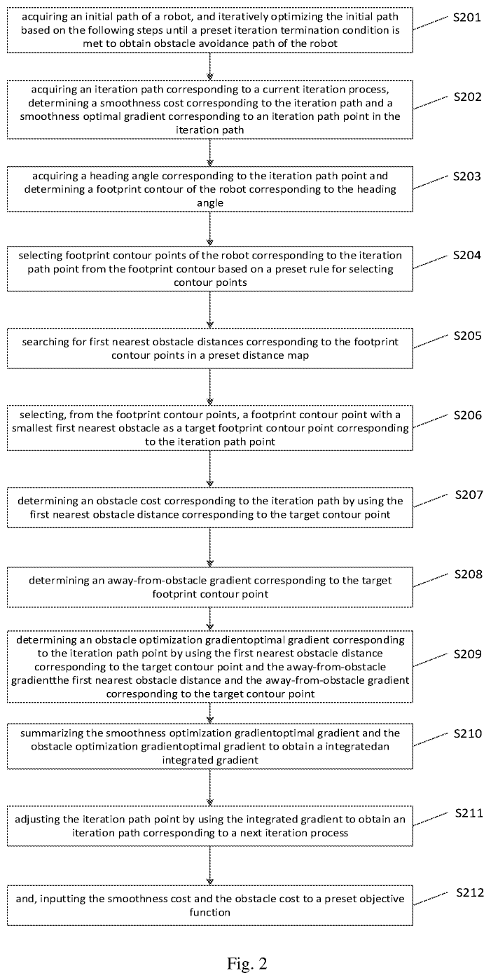

FIG. 2 is a schematic diagram of the implementation flow of another method for path optimization. The method can be applied to a robot, which may include the following steps:

S201, acquiring an initial path of a robot, and iteratively optimizing the initial path based on the following steps until a preset iteration termination condition is met to obtain obstacle avoidance path of the robot; and

S202, acquiring an iteration path corresponding to a current iteration process, determining a smoothness cost corresponding to the iteration path and a smoothness optimal gradient corresponding to an iteration path point in the iteration path;

S203, acquiring a heading angle corresponding to the iteration path point and determining a footprint contour of the robot corresponding to the heading angle;

S204, selecting footprint contour points of the robot corresponding to the iteration path point from the footprint contour based on a preset rule for selecting contour points;

S205, searching for first nearest obstacle distances corresponding to the footprint contour points in a preset distance map;

S206, selecting, from the footprint contour points, a footprint contour point with a smallest first nearest obstacle as a target footprint contour point corresponding to the iteration path point;

S207, determining an obstacle cost corresponding to the iteration path by using the first nearest obstacle distance corresponding to the target contour point;

S208, determining an away-from-obstacle gradient corresponding to the target footprint contour point;

S209, determining an obstacle optimal gradient corresponding to the iteration path point by using the first nearest obstacle distance and the away-from-obstacle gradient corresponding to the target contour point;

S210, summarizing the smoothness optimal gradient and the obstacle optimal gradient to obtain an integrated gradient;

S211, adjusting the iteration path point by using the integrated gradient to obtain an iteration path corresponding to a next iteration process; and

S212, inputting the smoothness cost and the obstacle cost to a preset objective function.

In some embodiments, an initial path of a robot typically includes n path points ({x₁,y₁}, . . . , {xₙ, yₙ}), where N is a positive integer, and the initial path can be iteratively optimized based on steps S202 to S212 until a preset iteration termination condition is met to obtain a robot obstacle avoidance path.

In some embodiments, this step is similar to step S102 and embodiments of the present application will not be repeated here.

In some embodiments, the obstacle closest to the robot's footprint contour needs to be considered. Therefore, for the iteration path corresponding to the current iterative process, acquire a heading angle corresponding to the iteration path point in the iteration path, and determine the robot's footprint contour under this the heading angle, so that the robot's footprint contour corresponding to the iteration path point in the iteration path can be determined.

In some embodiments, for a corresponding iteration path in the current iteration process, acquire iteration path points in the iteration path are acquired ({x₁, y₁}, . . . , {xₙ, yₙ}) The robot footprint contour of the heading angle is determined according to the corresponding heading angle, where, the i-th heading angle is acquired in the following way, so that robot the footprint contours respectively corresponding to the iteration path points in the iteration path can be determined.

θᵢ=a tan 2(y₁₊₁−yᵢ,xᵢ₊₁−xᵢ), 1≤i≤n−1;

θₙ=θₙ₋₁.

In some embodiments, for a robot footprint contour corresponding to an iteration path point in an iteration path, select footprint contour points of the robot corresponding to the iteration path point from the footprint contour based on a preset rule for selecting contour points. Where the rule for selecting contour points may be an arbitrary selection rule, for example, for a circular robot, the selection rule may be randomly selected, which is not limited by the embodiment of the present application.

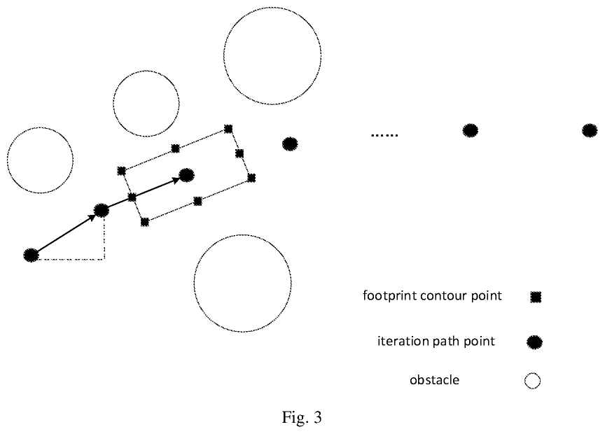

In some embodiments, for a robot's footprint contour i corresponding to an iteration path point (xᵢ,yᵢ) in an iteration path, taking a footprint contour 3 of the robot corresponding to an iteration path point (x₃,y₃) as an example, which is described by using a rectangle, that is, a rectangular footprint contour of the robot, and four endpoints and the midpoint of each edge in the robot's footprint contour are selected as the robot's footprint contour corresponding to the points iteration path point (x₃,y₃), as shown in FIG. 3. The processing of other iteration path points is similar, and this embodiment will not be repeated here.

In some embodiments, for a robot's footprint contour points corresponding to an iteration path point in an iteration path, a first nearest obstacle distance corresponding to the robot's footprint contour point, i.e., a distance between the footprint contour point of the robot and the nearest obstacle, can be searched for in a preset distance map. Where, the first nearest obstacle distance corresponding to the footprint contour point of the robot is searched for in the preset distance map based on the coordinates of the footprint contour point of the robot.

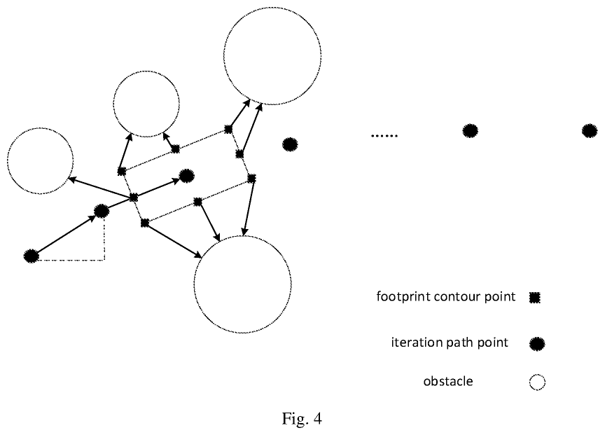

In some embodiments, for a robot's footprint contour point i corresponding to an iteration path point (xᵢ,yᵢ) in an iteration path, taking the robot's iteration path points corresponding to the iteration path point (x₃,y₃) as an example, as shown in FIG. 3, based on the coordinates of these footprint contour points of the robot, the first nearest obstacle distances respectively corresponding to these footprint contour points of the robot and the like can be found in the distance graph, as shown in FIG. 4. Processing of other iteration path points is similar, and the embodiments of the present application are not repeated here.

In some embodiments, for a robot's footprint contour points corresponding to an iteration path point in an iteration path, a footprint contour point with a smallest first nearest obstacle can be selected, from the footprint contour points, as a target footprint contour point corresponding to the iteration path point, which means that the first closest obstacle distance of the target footprint contour point is the smallest.

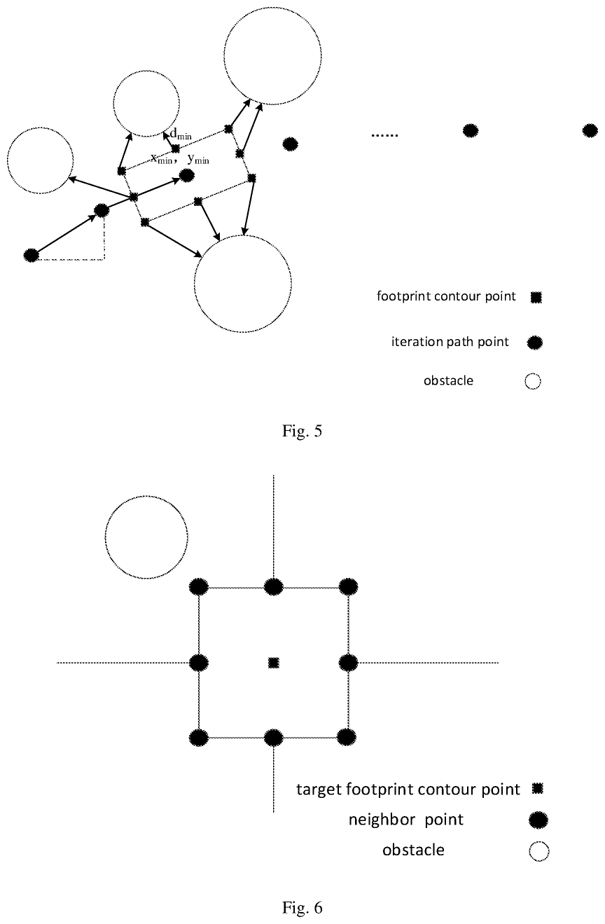

In some embodiments, for a robot's footprint contour points corresponding to an iteration path point (xᵢ,yᵢ) in an iteration path, taking the robot's iteration path points corresponding to the iteration path point (x₃,y₃) as an example, as shown in FIG. 3, a footprint contour point with a smallest first nearest obstacle (dₘᵢₙ) can be selected, from the footprint contour points, as a target footprint contour point (xₘᵢₙ,yₘᵢₙ) corresponding to the iteration path point (x₃,y₃), as shown in FIG. 5. Processing of other iteration path point is similar, and the embodiments of the present application are not repeated here.

For the target footprint contour point corresponding to the iteration path point in the iteration path, an obstacle cost corresponding to the iteration path can be determined by using the first nearest obstacle distance corresponding to the target footprint contour point.

For the target footprint contour points respectively corresponding to the iteration path points (xᵢ,yᵢ) in the iteration path, as shown in Table 2 below, an obstacle cost corresponding to the iteration path can be determined by using the first nearest obstacle distance corresponding to the target footprint contour point.

TABLE 2

| iteration path point | target footprint contour point |
|---|---|
| (x₁, y₁) | target footprint contour point 1 |
| . . . | . . . |
| (xₙ, yₙ) | target footprint contour point n |

In some embodiments, the embodiment of the present application can determine the obstacle cost corresponding to the iteration path in the following method: for the target footprint contour point corresponding to the iteration path point in the iteration path, input the first nearest obstacle distance corresponding to the target contour point to a preset obstacle cost algorithm, acquire an obstacle cost corresponding to the iteration path point output by the obstacle cost algorithm, and summarize the obstacle cost corresponding to the iteration path point to obtain the obstacle cost corresponding to the iteration path.

In some embodiments, for a target footprint contour point corresponding to the iteration path point (xᵢ,yᵢ) in an iteration path, input the first nearest obstacle distance corresponding to the target contour point to a preset obstacle cost algorithm, such that an obstacle cost corresponding to the iteration path point (xᵢ,yᵢ) output by the obstacle cost algorithm can be acquired, and summarize the obstacle costs corresponding to the iteration path points ({x₁,y₁}, . . . , {xₙ, yₙ}) to obtain the obstacle cost corresponding to the iteration path.

For the obstacle cost algorithm, as shown below, it can be seen that when the minimum distance between the obstacle and the robot's footprint contour is smaller than a preset distance, the obstacle cost is then calculated and obstacle optimization is started. The obstacle cost algorithm is as follows:

$${f}_{o} = \{ \begin{matrix}{( {d}_{min} - {d}_{δ} )}^{2} , & {d}_{min} < {d}_{δ} \\ 0 , & {d}_{min} \geq {d}_{δ}\end{matrix} ;$$

Where, the fₒ is an obstacle cost corresponding to the iteration path point, the dₘᵢₙ is the first nearest obstacle distance corresponding to the target contour point, the d_{δ} is a preset distance.

For the target footprint contour points corresponding to the iteration path points in the iteration path, an away-from-obstacle gradient corresponding to the target footprint contour points can be determined.

In some embodiments, for the target footprint contour points corresponding to the iteration path points (xᵢ, yᵢ) in an iteration path, the away-from-obstacle gradients respectively corresponding to these target footprint footprint contour points can be determined, as shown in Table 3.

TABLE 3

| iteration path | | away-from-obstacle |
|---|---|---|
| point | target footprint contour point | gradient |
| (x₁, y₁) | target footprint contour point 1 | away-from-obstacle |
| | | gradient 1 |
| . . . | . . . | . . . |
| (xₙ, yₙ) | target footprint contour point n | away-from-obstacle |
| | | gradient n |

In some embodiments, the away-from-obstacle gradient corresponding to the target footprint contour point, in an embodiment of the present application, is determined in the following method: for the target footprint contour point corresponding to the iteration path point in the iteration path, determine a neighbor point corresponding to the target footprint contour point, and search, in a distance map, for a second nearest obstacle distance corresponding to the neighbor point; select, from the neighbor points, a first neighbor point with the largest second nearest obstacle distance and a second neighbor point with the smallest second nearest obstacle distance; determine a distance between the first neighbor point and the second neighbor point, and determine the distance as the away-from-obstacle gradient corresponding to the target footprint contour point.

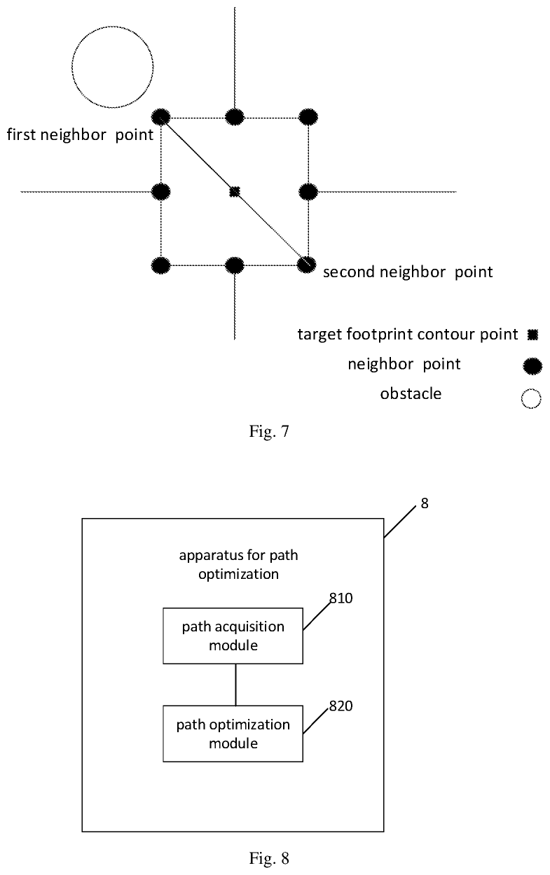

In some embodiments, for the target footprint contour point corresponding to the iteration path points (xᵢ,yᵢ) in the iteration path, taking the footprint contour point corresponding to the iteration path point (x₃,y₃) as an example, determine 8 neighbor points corresponding to the target footprint contour point, as shown in FIG. 6. According to the coordinates of the 8 neighbor points, search, in the distance map, for the second nearest obstacle distances corresponding to the 8 neighbor points. Select, from the 8 neighbor points, a first neighbor point with the largest second nearest obstacle distance and a second neighbor point with the smallest second nearest obstacle distance, as shown in FIG. 7. Determine a distance between the first neighbor point and the second neighbor point, and determine the distance as the away-from-obstacle gradient corresponding to the target footprint contour point. Processing of other iteration path point is similar, and the embodiments of the present application are not repeated here.

For the target footprint contour point corresponding to the iteration path points in the iteration path, the obstacle optimal gradient corresponding to the iteration path point can be determined by using the first nearest obstacle distance and the away-from-obstacle gradient corresponding to the target contour point.

In some embodiments, for the target footprint contour point corresponding to the iteration path points (xᵢ,yᵢ) in the iteration path, taking the footprint contour point corresponding to the iteration path point (x₃,y₃) as an example, determine the obstacle optimal gradient corresponding to the iteration path point (x₃,y₃) by using the first nearest obstacle distance and the away-from-obstacle gradient corresponding to the target contour point. Processing of other iteration path point is similar, and the embodiments of the present application are not repeated here.

In some embodiments, the obstacle optimal gradient corresponding to the iteration path point, in an embodiment of the present application, is determined in the following method: for the target footprint contour point corresponding to the iteration path points in the iteration path, input the first nearest obstacle distance and the away-from-obstacle gradient corresponding to the target contour point to a preset obstacle optimal gradient algorithm, and acquire an obstacle optimal gradient corresponding to the iteration path point output by the obstacle optimal gradient algorithm.

In some embodiments, for the target footprint contour point corresponding to the iteration path points (xᵢ,yᵢ) in the iteration path, taking the footprint contour point corresponding to the iteration path point (x₃,y₃) as an example, input the first nearest obstacle distance and the away-from-obstacle gradient corresponding to the target contour point to a preset obstacle optimal gradient algorithm, and acquire an obstacle optimal gradient corresponding to the iteration path point (x₃,y₃) output by the obstacle optimal gradient algorithm. Processing of other iteration path point is similar, and the embodiments of the present application are not repeated here.

In some embodiments, for the obstacle optimal gradient algorithm, as shown below, it can be seen that when the minimum distance between the obstacle and the robot's footprint contour is smaller than a preset distance, the obstacle cost is then calculated and the obstacle optimization is started. The obstacle optimal gradient algorithm is as follows:

$$\frac{\partial {f}_{o}}{\partial x} = \{ \begin{matrix}2 * ( {d}_{min} - {d}_{δ} ) * {grad}_{min} , & {d}_{min} < {d}_{δ} \\ 0 , & {d}_{min} \geq {d}_{δ}\end{matrix} ;$$

Where, the ∂fₒ/∂ₓ the obstacle optimal gradient, the dₘᵢₙ is the first nearest obstacle distance corresponding to the target contour point, the d_{δ} is a preset distance, the gradₘᵢₙ is the away-from-obstacle gradient.

In some embodiments, for the smoothness optimal gradient corresponding to the iteration path point in the iteration path and the obstacle optimal gradient corresponding to the iteration path point in the iteration path, an integrated gradient corresponding to the iteration path point in the iteration path can be obtained by summarizing the smoothness optimal gradient and the obstacle optimal gradient.

In some embodiments, for the smoothness optimal gradient corresponding to the iteration path points (xᵢ,yᵢ) in the iteration path and the obstacle optimal gradient corresponding to the iteration path points (xᵢ,yᵢ) in the iteration path, an integrated gradient corresponding to the iteration path points (xᵢ,yᵢ) in the iteration path can be obtained by summarizing the smoothness optimal gradient and the obstacle optimal gradient.

In some embodiments, for the integrated gradient corresponding to the iteration path point in the iteration path, the iteration path points in the iteration path can be adjusted by using the integrated gradient, and in some embodiments, the coordinate values may be adjusted so that the iteration path corresponding to the next iteration process can be obtained.

In some embodiments, for the integrated gradient corresponding to the iteration path point in the iteration path, taking the iteration path point (x₃,y₃) as an example, the iteration path point (x₃,y₃) in the iteration path can be adjusted by using the integrated gradient, processing of other iteration path points are similar, so the embodiment will not be repeated here one by one, so that the iteration path corresponding to the next iteration process can be acquired.

In some embodiments, this step is similar to step S106 described above and embodiments of the present application are not repeated here.

The present application also relates to an apparatus for path optimization 8, as shown in FIG. 8, the apparatus may include a path acquisition module 810 and a path optimization module 820.

The path acquisition module 810, is configured for acquiring an initial path of a robot;

The path optimization module 820, is configured for iteratively optimizing the initial path based on the following steps until a preset iteration termination condition is met to acquire an obstacle avoidance path of the robot:
acquiring an iteration path corresponding to the current iteration process, determining a smoothness cost corresponding to the iteration path and a smoothness optimal gradient corresponding to iteration path points in the iteration path;
determining a robot footprint contour corresponding to the iteration path point, and searching for a first nearest obstacle distance corresponding to the footprint contour;
determining an obstacle cost corresponding to the iteration path and an obstacle optimal gradient corresponding to the iteration path point based on the first nearest obstacle distance;
adjusting the iteration path points based on the smoothness optimal gradient and the obstacle optimal gradient to acquire an iteration path corresponding to a next iteration process; and
inputting the smoothness cost and the obstacle cost to a preset objective function.

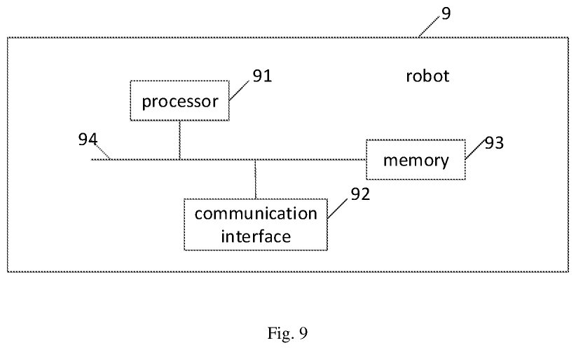

The present application also relates to a robot 9, which, as shown in FIG. 9, includes a processor 91, a communication interface 92, a memory 93 and a communication bus 94, where the processor 91, the communication interface 92 and the memory 93 communicate with each other through the communication bus 94,
the memory 93 is configured for storing computer programs; and
the processor 91 is configured to implement the following steps:
acquiring an initial path of a robot, and iteratively optimizing the initial path based on the following steps until a preset iteration termination condition is met to acquire an obstacle avoidance path of the robot; acquiring an iteration path corresponding to the current iteration process, determining a smoothness cost corresponding to the iteration path and a smoothness optimal gradient corresponding to iteration path points in the iteration path; determining a robot footprint contour corresponding to the iteration path point, and searching for a first nearest obstacle distance corresponding to the footprint contour; determining an obstacle cost corresponding to the iteration path and an obstacle optimal gradient corresponding to the iteration path point based on the first nearest obstacle distance; adjusting the iteration path points based on the smoothness optimal gradient and the obstacle optimal gradient to acquire an iteration path corresponding to a next iteration process; and inputting the smoothness cost and the obstacle cost to a preset objective function.

The communication bus mentioned by the robot can be Peripheral Component Interconnect (PCI) bus or Extended Industry Standard Architecture (EISA) bus, etc. The communication bus can be divided into address bus, data bus, control bus and so on. For ease of presentation, only one thick line is used in the figure, but it does not mean that there is only one bus or one type of bus.

The communication interface is used for communication between the robot and other devices.

The memory may include Random Access Memory (RAM), non-volatile memory, at least one disk memory. In some embodiments, the memory may also be at least one storage device located remotely from the processor.

The processor can be a general-purpose processor, including a Central Processing Unit (CPU), a Network Processor (NP), and the like; It can also be Digital Signal Processing (DSP), Application Specific Integrated Circuit (ASIC), Field-Programmable Gate Array (FPGA) or other programmable logic devices, discrete gates or transistor logic devices, and discrete hardware components.

The present application also provides a storage medium where instructions are stored on the storage medium, where, the program, when executed by a processor, implements the method for path optimization according to any one of the above embodiments.

The present application also provides a computer program product including instructions that, when run on a computer, cause the computer to perform method for path optimization described in any of the above embodiments.

In some embodiments it may be implemented in whole or in part by software hardware firmware or any combination thereof. When implemented in software, it can be implemented in whole or in part in the form of a computer program product. The computer program product includes one or more computer instructions. When the computer program instructions are loaded and executed on a computer, the processes or functions described in accordance with embodiments of the present application are generated in whole or in part. The computer may be a general purpose computer, a special purpose computer, a computer network, or other programmable device. The computer instructions may be stored in a storage medium or transmitted from one storage medium to another. For example, the computer instructions may be transmitted from one Web site, computer, server, or data center to another Web site, computer, server, or data center via wired (e.g. coaxial cable, optical fiber, digital subscriber line (DSL)) or wireless (e.g. infrared, wireless, microwave, etc.). The storage medium may be any available medium accessible to a computer or a data storage device such as a server, data center, or the like that includes one or more available media integration. The usable media may be magnetic media (e.g. floppy disk, hard disk, magnetic tape), optical media (e.g. DVD), or semiconductor media (e.g. Solid State Disk (SSD)), etc.

It should be noted that relational terms such as first and second are used herein only to distinguish one entity or operation from another and do not necessarily require or imply any such actual relationship or order between these entities or operations. Moreover, the terms “including”, “including” or any other variation thereof are intended to encompass non-exclusive inclusion, so that a process, method, article or equipment that includes a set of elements includes not only those elements but also other elements that are not explicitly listed or are inherent to such a process, method, article or equipment. In the absence of further limitations, an element defined by the phrase “includes an” does not preclude the existence of another identical element in the process, method, article or equipment in which the element is included.

Each of the embodiments in this specification is described in a related manner and the same and similar parts between the embodiments can be referred to each other. Each embodiment focuses on the differences from other embodiments. Particularly for the system embodiment since it is substantially similar to the method embodiment the description is relatively simple and reference can be made to the partial description of the method embodiment where relevant.

The above description is only a preferred embodiment of the present application and is not intended to limit the scope of protection of the present application. Any modifications, equivalents, modifications, etc. made within the spirit and principles of this application are within the scope of protection of this application.

1. A method for path optimization, comprising:
acquiring an initial path of a robot, and iteratively optimizing the initial path based on the following steps until a preset iteration termination condition is met to obtain obstacle avoidance path of the robot:
acquiring an iteration path corresponding to a current iteration process, determining a smoothness cost corresponding to the iteration path and a smoothness optimal gradient corresponding to an iteration path point in the iteration path;
determining a robot's footprint contour corresponding to the iteration path point, and searching for a first nearest obstacle distance corresponding to the footprint contour;
determining an obstacle cost corresponding to the iteration path and an obstacle optimal gradient corresponding to the iteration path point based on the first nearest obstacle distance;
adjusting the iteration path point based on the smoothness optimal gradient and the obstacle optimal gradient to acquire an iteration path corresponding to a next iteration process; and
inputting the smoothness cost and the obstacle cost to a preset objective function.

2. The method according to claim 1, wherein, determining the robot's footprint contour corresponding to the iteration path point comprises:
acquiring a heading angle corresponding to the iteration path point and determining a footprint contour of the robot corresponding to the heading angle;
selecting footprint contour points of the robot corresponding to the iteration path point from the footprint contour based on a preset rule for selecting contour points.

3. The method according to claim 1, wherein searching for the first nearest obstacle distance corresponding to the footprint contour comprises:
searching for first nearest obstacle distances corresponding to the footprint contour points in a preset distance map.

4. The method according to claim 1, wherein,
determining the obstacle cost corresponding to the iteration path and the obstacle optimal gradient corresponding to the iteration path point based on the first nearest obstacle distance comprises:
selecting, from the footprint contour points, a footprint contour point with a smallest first nearest obstacle as a target footprint contour point corresponding to the iteration path point;
determining an obstacle cost corresponding to the iteration path by using the first nearest obstacle distance corresponding to the target contour point;
determining an away-from-obstacle gradient corresponding to the target footprint contour point; and
determining an obstacle optimal gradient corresponding to the iteration path point by using the first nearest obstacle distance and the away-from-obstacle gradient corresponding to the target contour point.

5. The method according to claim 4, wherein, determining the obstacle cost corresponding to the iteration path by using the first nearest obstacle distance corresponding to the target contour point comprises:
inputting the first nearest obstacle distance corresponding to the target contour point to a preset obstacle cost algorithm; and
acquiring an obstacle cost corresponding to the iteration path point output by the obstacle cost algorithm, and summarizing the obstacle cost corresponding to the iteration path point to obtain the obstacle cost corresponding to the iteration path.

6. The method according to claim 5, wherein the obstacle cost algorithm comprises:
$${f}_{o} = \{ \begin{matrix}{( {d}_{min} - {d}_{δ} )}^{2} , & {d}_{min} < {d}_{δ} \\ 0 , & {d}_{min} \geq {d}_{δ}\end{matrix} ;$$
wherein, the fₒ is an obstacle cost corresponding to the iteration path point, the dₘᵢₙ is the first nearest obstacle distance corresponding to the target contour point, the d_{δ} is a preset distance.

7. The method according to claim 4, wherein determining the away-from-obstacle gradient corresponding to the target footprint contour point comprises
determining a neighbor point corresponding to the target footprint contour point, and searching for a second nearest obstacle distance corresponding to the neighbor point;
selecting, from the neighbor points, a first neighbor point with a largest second nearest obstacle distance and a second neighbor point with a smallest second nearest obstacle distance;
determining a distance between the first neighbor point and the second neighbor point, and determining the distance as the away-from-obstacle gradient corresponding to the target footprint contour point.

8. The method according to claim 4, wherein determining the obstacle optimal gradient corresponding to the iteration path point by using the first nearest obstacle distance and the away-from-obstacle gradient corresponding to the target contour point comprises:
inputting the away-from-obstacle gradient and the first nearest obstacle distance corresponding to the target contour point to a preset obstacle optimal gradient algorithm; and
acquiring an obstacle optimal gradient corresponding to the iteration path point output by the obstacle optimal gradient algorithm.

9. The method according to claim 8, wherein the obstacle cost algorithm comprises:
$$\frac{\partial {f}_{o}}{\partial x} = \{ \begin{matrix}2 * ( {d}_{min} - {d}_{δ} ) * {grad}_{min} , & {d}_{min} < {d}_{δ} \\ 0 , & {d}_{min} \geq {d}_{δ}\end{matrix} ;$$
wherein, the ∂fₒ/∂ₓ is the obstacle optimal gradient, the dₘᵢₙ is the first nearest obstacle distance corresponding to the target contour point, the d_{δ} is a preset distance, the gradₘᵢₙ is the away-from-obstacle gradient.

10. The method according to claim 1, wherein, adjusting the iteration path points based on the smoothness optimal gradient and the obstacle optimal gradient to acquire the iteration path corresponding to the next iteration process comprises:
summarizing the smoothness optimal gradient and the obstacle optimal gradient to obtain an integrated gradient; and
adjusting the iteration path point by using the integrated gradient to obtain an iteration path corresponding to a next iteration process.

11. The method according to claim 1, wherein iteratively optimizing the initial path until the preset iteration termination condition is met comprises:
iteratively optimizing the initial path until an objective function satisfies a convergence condition, until the number of iterations reaches a preset number of iterations or until the iteration duration reaches a preset duration.

12. The method according to claim 1, wherein the objective function comprises:
$${min}_{x} {λ}_{1} {f}_{ns} + {λ}_{2} {f}_{no} ;$$
wherein, the fₙₛ is the smoothness cost, the fₙₒ is the obstacle cost, the x is coordinates of the iteration path point.

13. (canceled)

14. A robot, comprising a processor, a communication interface, a memory and a communication bus, wherein the processor, the communication interface and the memory communicate with each other through the communication bus;
the memory is configured for storing computer programs; and
the processor is configured to implement a method for path optimization, the method comprising:
acquiring an initial path of a robot, and iteratively optimizing the initial path based on the following steps until a preset iteration termination condition is met to obtain obstacle avoidance path of the robot:
acquiring an iteration path corresponding to a current iteration process, determining a smoothness cost corresponding to the iteration path and a smoothness optimal gradient corresponding to an iteration path point in the iteration path;
determining a robot's footprint contour corresponding to the iteration path point, and searching for a first nearest obstacle distance corresponding to the footprint contour;
determining an obstacle cost corresponding to the iteration path and an obstacle optimal gradient corresponding to the iteration path point based on the first nearest obstacle distance;
adjusting the iteration path point based on the smoothness optimal gradient and the obstacle optimal gradient to acquire an iteration path corresponding to a next iteration process; and
inputting the smoothness cost and the obstacle cost to a preset objective function.

15. A computer-readable storage medium on which a program is stored, wherein, the program, when executed by a processor, implements the method according to claim 1.

16. The robot according to claim 14, wherein, determining the robot's footprint contour corresponding to the iteration path point comprises:
acquiring a heading angle corresponding to the iteration path point and determining a footprint contour of the robot corresponding to the heading angle;
selecting footprint contour points of the robot corresponding to the iteration path point from the footprint contour based on a preset rule for selecting contour points.

17. The robot according to claim 14, wherein searching for the first nearest obstacle distance corresponding to the footprint contour comprises:
searching for first nearest obstacle distances corresponding to the footprint contour points in a preset distance map.

18. The robot according to claim 14, wherein, determining the obstacle cost corresponding to the iteration path and the obstacle optimal gradient corresponding to the iteration path point based on the first nearest obstacle distance comprises:
selecting, from the footprint contour points, a footprint contour point with a smallest first nearest obstacle as a target footprint contour point corresponding to the iteration path point;
determining an obstacle cost corresponding to the iteration path by using the first nearest obstacle distance corresponding to the target contour point;
determining an away-from-obstacle gradient corresponding to the target footprint contour point; and
determining an obstacle optimal gradient corresponding to the iteration path point by using the first nearest obstacle distance and the away-from-obstacle gradient corresponding to the target contour point.

19. The robot according to claim 18, wherein, determining the obstacle cost corresponding to the iteration path by using the first nearest obstacle distance corresponding to the target contour point comprises:
inputting the first nearest obstacle distance corresponding to the target contour point to a preset obstacle cost algorithm; and
acquiring an obstacle cost corresponding to the iteration path point output by the obstacle cost algorithm, and summarizing the obstacle cost corresponding to the iteration path point to obtain the obstacle cost corresponding to the iteration path.

20. The robot according to claim 19, wherein the obstacle cost algorithm comprises:
$${f}_{o} = \{ \begin{matrix}{( {d}_{min} - {d}_{δ} )}^{2} , & {d}_{min} < {d}_{δ} \\ 0 , & {d}_{min} \geq {d}_{δ}\end{matrix} ;$$
wherein, the fₒ is an obstacle cost corresponding to the iteration path point, the dₘᵢₙ is the first nearest obstacle distance corresponding to the target contour point, the d_{δ} is a preset distance.
